(19) United States
(12) Patent Application Publication
(10) Pub. No.: US 2007/0139699 A1
(43) Pub. Date: Jun. 21, 2007

(54) Image forming apparatus and method of controlling the image forming apparatus

(75) Inventor: Jin-hyung Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/583,836

(22) Filed: Oct. 20, 2006

(30) Foreign Application Priority Data
Dec. 20, 2005 (KR) 2005-126100

(51) Int. Cl. G06F 3/12

(52) U.S. Cl. 358/1.15

(57) ABSTRACT

An image forming apparatus and a method of controlling the image forming apparatus. The method includes allowing the image forming apparatus and the external device to communicate with each other; and controlling the driving of the image forming apparatus according to the communication interface used in the communication between the image forming apparatus and the external device. Accordingly, it is possible to maximize convenience when using an image forming apparatus by automatically controlling the driving of an image forming apparatus according to the communication interface used in communication between an external device and the image forming apparatus.

### CROSS-REFERENCE TO RELATED APPLICATIONS

This application claims priority under 35 U.S.C. §119(a) from Korean Patent Application No. 10-2005-0126100, filed on Dec. 20, 2005, in the Korean Intellectual Property Office, the disclosure of which is incorporated herein in its entirety by reference

### BACKGROUND OF THE INVENTION

1. Field of the Invention

The present general inventive concept relates to an image forming apparatus that supports a plurality of communication interfaces, and more particularly, to an image forming apparatus and a method of controlling the image forming apparatus in which the driving of the image forming apparatus can be controlled using a communication interface used to receive print data from an external device.

2. Description of the Related Art

Image forming apparatuses which can be used by being connected to a plurality of external devices generally support a plurality of communication interfaces. Communication interfaces that are supported by image forming apparatuses are classified into local communication interfaces such as IEEE 1284 interfaces or USB interfaces, personal area network (PAN) interfaces such as ultra wide band (UWB) interfaces or Bluetooth interfaces, and remote area communication interfaces such as local area network (LAN) interfaces (e.g., IEEE 802.11 interfaces, IEEE 802.3 interfaces, and IEEE 1284 interfaces), public switched telephone network (PSTN) interfaces, and integrated services digital network (ISDN) interfaces.

Image forming apparatuses receive print data to be printed from an external device via a given communication interface and then the image forming apparatuses store or print the received print data.

Conventionally, a user is required to input print settings to an image forming apparatus with an external device whenever using the image forming apparatus regardless of the type of communication interface used to communicate between the external device and the image forming apparatus, thus causing inconveniences.

### SUMMARY OF THE INVENTION

The present general inventive concept provides an image forming apparatus and a method of controlling the image forming apparatus in which driving of the image forming apparatus is controlled using a communication interface used to receive print data from an external device.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of controlling an image forming apparatus that provides an external device with a plurality of communication interfaces, the method including: allowing the image forming apparatus and the external device to communicate with each other; and controlling the driving of the image forming apparatus according to the communication interface used in the communication between the image forming apparatus and the external device.

The foregoing and/or other aspects of the present general inventive concept may also be achieved by providing a computer-readable recording medium containing a method of controlling an image forming apparatus that provides an external device with a plurality of communication interfaces, the method including: allowing the image forming apparatus and the external device to communicate with each other; and controlling the driving of the image forming apparatus according to the communication interface used in the communication between the image forming apparatus and the external device.

The foregoing and/or other aspects of the present general inventive concept may also be achieved by providing an image forming apparatus that provides an external device with a plurality of communication interfaces, the image forming apparatus including: a communication unit which communicates with the external device; and a control unit which controls the driving of the image forming apparatus according to a communication interface used in the communication between the communication unit and the external device.

The foregoing and/or other aspects of the present general inventive concept may also be achieved by providing a method of controlling an image forming apparatus that provides an external device with a plurality of communication interfaces, the method including: identifying the communication interface used in communication between the image forming apparatus and the external device; and controlling the image forming apparatus according to the communication interface identified.

The foregoing and/or other aspects of the present general inventive concept may also be achieved by providing a computer-readable recording medium containing a method of controlling an image forming apparatus that provides an external device with a plurality of communication interfaces, the method including: identifying the communication interface used in communication between the image forming apparatus and the external device; and controlling the image forming apparatus according to the communication interface identified.

The foregoing and/or other aspects of the present general inventive concept may also be achieved by providing a method of controlling an image forming apparatus that provides an external device with a plurality of communication interfaces, the method including: determining whether a request to store settings corresponding to each of a plurality of communications interfaces provided by the image forming apparatus has been input; and providing a user interface to input or edit the settings corresponding to each of the plurality of communication interfaces provided by the image forming apparatus if it is determined that the request is input; and storing the input or edited settings.

The foregoing and/or other aspects of the present general inventive concept may also be achieved by providing a computer-readable recording medium containing a method of controlling an image forming apparatus that provides an external device with a plurality of communication interfaces, the method including: determining whether a request to store settings corresponding to each of a plurality of communications interfaces provided by the image forming apparatus has been input; and providing a user interface to input or edit the settings corresponding to each of the plurality of communication interfaces provided by the image forming apparatus if it is determined that the request is input; and storing the input or edited settings.

The foregoing and/or other aspects of the present general inventive concept may also be achieved by providing an image forming apparatus that provides an external device with a plurality of communication interfaces, the image forming apparatus including: a communication unit to communicate with an external device; and an interface determination unit to determine one of a plurality of communication interfaces used to receive data from the external device; and a settings storage unit to store settings associated with each of the plurality of communication interfaces; and a settings input unit to provide an interface to input or edit the settings stored in the settings storage unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a method of controlling an image forming apparatus according to an exemplary embodiment of the present general inventive concept;

FIG. 2 is a flowchart illustrating an example of operation 140 of FIG. 1;

FIG. 3 is a flowchart illustrating storing of settings in a method of controlling an image forming apparatus according to an exemplary embodiment of the present general inventive concept;

FIG. 4 is a block diagram illustrating an image forming apparatus according to an exemplary embodiment of the present general inventive concept; and

FIG. 5 is a diagram illustrating a user interface provided by an image forming apparatus according to an exemplary embodiment of the present general inventive concept, or a method of controlling an image forming apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

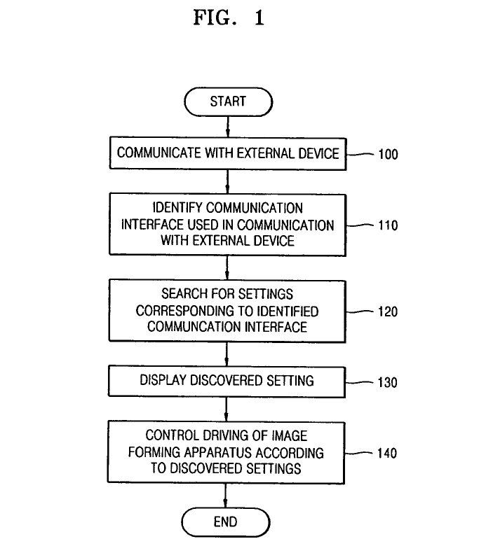

FIG. 1 is a flowchart illustrating a method of controlling an image forming apparatus according to an exemplary embodiment of the present general inventive concept. Referring to FIG. 1, in operation 100, an image forming apparatus receives print data by communicating with an external device, such as, for example, a host device via a communication interface. The communication interface may be a local communication interface such as an IEEE 1284 interface or a USB interface, a PAN interface such as a UWB interface or a Bluetooth interface, a LAN interface such as an IEEE 802.11 interface, an IEEE 802.3 interface, or an IEEE 1284 interface, a PSTN interface, or an ISDN interface.

In operation 110, the type of the communication interface is identified.

In operation 120, settings corresponding to the identification result of operation 110 are searched. The settings may be stored in a storage medium of the image forming apparatus or may be received from a user interface via a user interface illustrated in FIG. 5. The settings set a print environment for the print data and may include settings to determine when to print the print data, settings to determine whether to store the print data, and settings to determine whether to print the print data according to a predetermined policy.

For example, since a PAN interface such as a Bluetooth interface or a UWB interface are mostly used for personal purposes in the proximity of the image forming apparatus, the print environment set by the settings discovered in operation 120 allows the print data to be immediately printed in response to a print command, but does not allow the print data to be stored in the image forming apparatus. On the other hand, a LAN interface can be used in a relatively distant area from the image forming apparatus and allows the print data to be temporarily stored in the image forming apparatus and then to be printed according to a predefined policy such as a security policy based on password inputs or ID card recognition.

In operation 130, the discovered settings of operation 120 are displayed to the user.

In operation 140, the driving of the image forming apparatus is controlled according to the discovered settings of operation 120.

The method of controlling an image forming apparatus according to the current embodiment of the present general inventive concept can be performed by a printer server. In this case, the printer server may be a server separate from an image forming apparatus or may be an embedded web server (EWS).

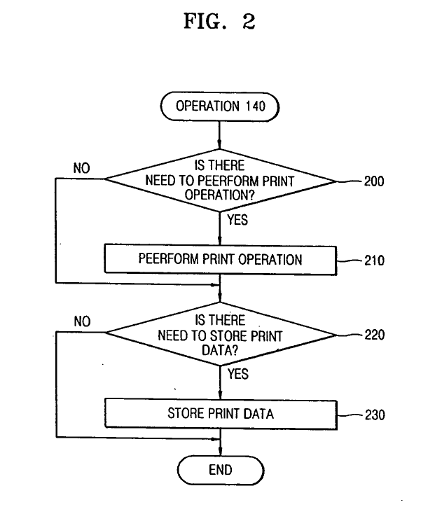

FIG. 2 is a flowchart illustrating an example of operation 140 of FIG. 1. Referring to FIG. 2, operation 140 comprises operations 200 through 230.

In operation 200, it is determined whether the discovered settings include settings to perform a print operation.

In operation 210, if the discovered settings are determined in operation 200 to include settings to perform a print operation, the print data is printed.

In operation 220, if the printing of the print data is terminated or if the discovered settings are determined in operation 200 not to include settings to perform a print operation, operation 220 determines whether the discovered settings include settings to store the print data.

In operation 230, if the discovered settings are determined in operation 220 to include settings to store the print data, the print data is stored in the storage medium of the image forming apparatus.

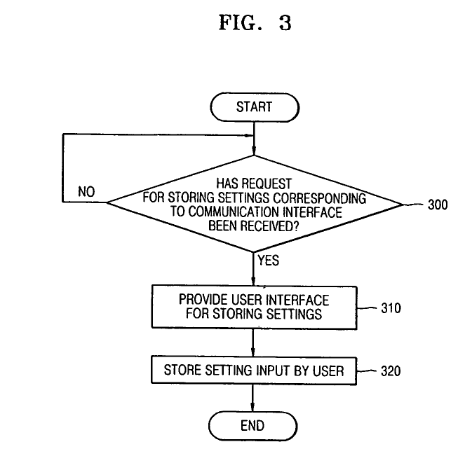

FIG. 3 is a flowchart illustrating storing of settings in a method of controlling an image forming apparatus according to an exemplary embodiment of the present general inventive concept. Referring to FIG. 3, in operation 300, it is determined whether a user has requested the storing of settings corresponding to each of a plurality of communication interfaces provided by the image forming apparatus.

In operation 310, if it is determined in operation 300 that the user has requested the storing of settings regarding each of the communication interfaces provided by the image forming apparatus, a user interface such as the one illustrated in FIG. 5 is provided to the user so that the user can input or edit the settings regarding each of the communication interfaces provided by the image forming apparatus.

In operation 320, the settings input or edited by the user are stored.

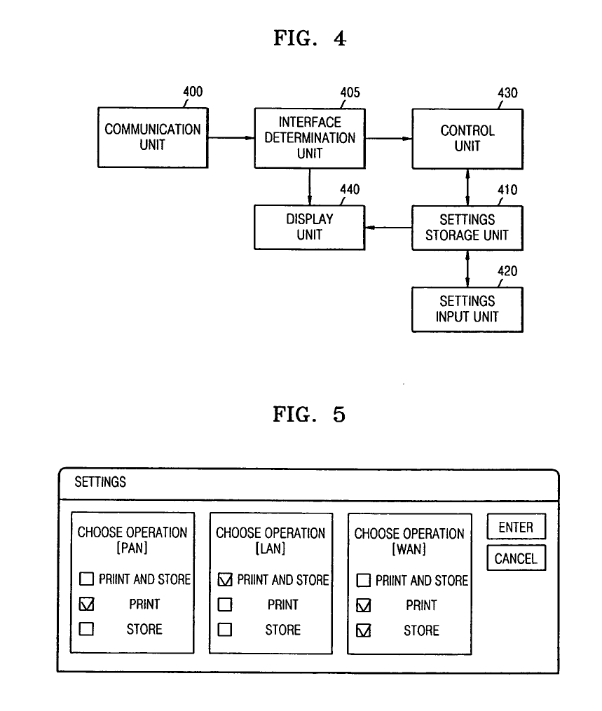

FIG. 4 is a block diagram illustrating an image forming apparatus according to an exemplary embodiment of the present general inventive concept. Referring to FIG. 4, the image forming apparatus may include a communication unit 400, an interface determination unit 405, a settings storage unit 410, a settings input unit 420, a control unit 430, and a display unit 440.

The communication unit 400 communicates with an external device which is located outside the image forming apparatus.

The interface determination unit 405 identifies the communication interface used to receive print data from the external device. The communication interface may be classified, according to its communication range, into a local communication interface such as an IEEE 1284 interface or a USB interface, a PAN interface such as a UWB interface or a Bluetooth interface, or a remote communication interface such as a LAN interface (e.g., an IEEE 802.11 interface, an IEEE 802.3 interface, or an IEEE 1284 interface), a PSTN interface, or an ISDN interface.

The settings storage unit 410 stores settings regarding each of a plurality of communication interfaces provided by the image forming apparatus. Here, the settings set a print environment for the print data and may include settings to determine when to print the print data, settings to determine whether to store the print data, and settings to determine whether to print the print data in a secure print environment.

For example, since a PAN interface such as a Bluetooth interface or a UWB interface are mostly used for personal purposes in the proximity of the image forming apparatus, the print environment set by the settings stored in the settings storage unit 410 allows the print data to be immediately printed in response to a print command, but does not allow the print data to be stored in the image forming apparatus. On the other hand, a LAN interface can be used in a relatively distant area from the image forming apparatus and allows the print data to be temporarily stored in the image forming apparatus and then to be printed according to a predefined policy such as a security policy based on password inputs or ID card recognition.

The settings input unit 420 provides a user interface which allows the user to input or edit the settings stored in the settings storage unit 410 and receives settings regarding each of the communication interfaces provided by the image forming apparatus from the user.

In the embodiment exemplified by FIG. 4, the settings storage unit 410 stores the settings input by the user in the settings input unit 420.

The control unit 430 controls the driving of the image forming apparatus according to the settings stored in the settings storage unit 410 corresponding to the identification result provided by the interface determination unit 405.

The display unit 440 displays the identification result provided by the interface determination unit 405 to the user. In addition, the display unit 440 displays the settings corresponding to the identification result provided by the interface determination unit 405 to the user.

The image forming apparatus according to the current embodiment of the present general inventive concept may be realized as a printer server. In this case, the printer server may be a server separate from a typical image forming apparatus or may be an EWS.

The present general inventive concept can also be embodied as computer-readable codes on a computer-readable recording medium. The computer-readable recording medium may be any type of recording device that can store data in a computer-readable manner. Examples of the computer-readable recording medium include a ROM, a RAM, a CD-ROM, a magnetic tape, a floppy disc, an optical data storage, and a carrier wave (e.g., data transmission through the Internet).

According to the present general inventive concept, it is possible to control the driving of an image forming apparatus according to the communication interface used to receive print data from an external device.

Therefore, it is possible to maximize convenience when using an image forming apparatus by automatically controlling the driving of an image forming apparatus according to the communication interface used in communication between an external device and the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling an image forming apparatus that provides an external device with a plurality of communication interfaces, the method comprising:
allowing the image forming apparatus and the external device to communicate with each other; and
controlling the driving of the image forming apparatus according to the communication interface used in the communication between the image forming apparatus and the external device.

2. The method of claim 1, further comprising:
storing settings corresponding to each of the communication interfaces provided by the image forming apparatus.

3. The method of claim 2, wherein the controlling comprises controlling the driving of the image forming apparatus according to the stored settings corresponding to the communication interface used in the communication between the image forming apparatus and the external device.

4. The method of claim 2, further comprising:
providing a user interface which allows the settings corresponding to each of the communication interfaces provided by the image forming apparatus to be stored.

5. The method of claim 2, wherein the settings comprise one of settings to store print data and settings regarding a policy associated with a print operation.

6. The method of claim 5, wherein the policy associated with the print operation is a security policy which can be based on password inputs or ID card recognition.

7. The method of claim 1, further comprising:
displaying the communication interface used in the communication between the image forming apparatus and the external device to a user.

8. The method of claim 2, further comprising:
displaying the stored settings corresponding to the communication interface used in the communication between the image forming apparatus and the external device to a user.

9. The method of claim 1, wherein controlling the driving of the image forming apparatus according to the communication interface used in the communication between the image forming apparatus and the external device is realized by a printer server.

10. The method of claim 9, wherein the printer server is a server separate from the image forming apparatus or an embedded web server (EWS).

11. A computer-readable recording medium containing a method of controlling an image forming apparatus that provides an external device with a plurality of communication interfaces, the method comprising:
allowing the image forming apparatus and the external device to communicate with each other; and
controlling the driving of the image forming apparatus according to the communication interface used in the communication between the image forming apparatus and the external device.

12. An image forming apparatus that provides an external device with a plurality of communication interfaces, the image forming apparatus comprising:
a communication unit which communicates with the external device; and
a control unit which controls the driving of the image forming apparatus according to the communication interface used in the communication between the communication unit and the external device.

13. The image forming apparatus of claim 12, further comprising:
a settings storage unit which stores settings corresponding to each of the communication interfaces provided by the image forming apparatus.

14. The image forming apparatus of claim 13, wherein the control unit controls the driving of the image forming apparatus according to the settings stored in the settings storage unit corresponding to the communication interface used in the communication between the communication unit and the external device.

15. The image forming apparatus of claim 13, further comprising:
a settings input unit which receives the settings corresponding to each of the communication interfaces provided by the image forming apparatus from a user.

16. The image forming apparatus of claim 15, wherein the settings input unit provides a user interface which allows the settings corresponding to each of the communication interfaces provided by the image forming apparatus to be stored.

17. The image forming apparatus of claim 12, further comprising:
a display unit which displays the communication interface used in the communication between the communication unit and the external device to a user.

18. The image forming apparatus of claim 13, further comprising:
a display unit which displays the communication interface used in the communication between the communication unit and the external device to a user.

19. The image forming apparatus of claim 18, wherein the display unit displays the settings stored in the settings storage unit corresponding to the communication interface used in the communication between the communication unit and the external device to a user.

20. The image forming apparatus of claim 12, wherein the control unit is being realized as a printer server.

21. The image forming apparatus of claim 20, wherein the printer server is a server separate from a typical image forming apparatus or an embedded web server (EWS).

22. A method of controlling an image forming apparatus that provides an external device with a plurality of communication interfaces, the method comprising:
identifying the communication interface used in communication between the image forming apparatus and the external device; and
controlling the image forming apparatus according to the communication interface identified.

23. The method of claim 22, further comprising:
storing settings corresponding to each of the communication interfaces provided by the image forming device to communicate with an external device.

24. The method of claim 23, wherein the controlling comprises controlling the driving of the image forming apparatus according to the stored settings corresponding to the communication interface identified.

25. The method of claim 23, further comprising:
displaying the communication interface identified and the stored settings corresponding to the communication interface identified to a user.

26. The method of claim 25, further comprising:
providing a user interface which allows settings corresponding to the communication interface identified to be input or edited by the user.

27. The method of claim 23, wherein the settings comprise one of settings to store print data and settings regarding a policy associated with a print operation.

28. The method of claim 27, wherein the policy associated with the print operation is a security policy which can be based on password inputs or ID card recognition.

29. The method of claim 22, wherein controlling the image forming apparatus according to the communication interface identified is realized by a printer server.

30. The method of claim 29, wherein the printer server is a server separate from the image forming apparatus or an embedded web server (EWS).

31. A computer-readable recording medium containing a method of controlling an image forming apparatus that provides an external device with a plurality of communication interfaces, the method comprising:
identifying the communication interface used in communication between the image forming apparatus and the external device; and
controlling the image forming apparatus according to the communication interface identified.

32. A method of controlling an image forming apparatus that provides an external device with a plurality of communication interfaces, the method comprising:
determining whether a request to store settings corresponding to each of a plurality of communications interfaces provided by the image forming apparatus has been input;
providing a user interface to input or edit the settings corresponding to each of the plurality of communication interfaces provided by the image forming apparatus if it is determined that the request is input; and
storing the input or edited settings.

33. The method of claim 32, further comprising:
driving the image forming apparatus according to the stored settings corresponding to the communication interfaced used to communicate between the external device and the image forming apparatus.

34. A computer-readable recording medium containing a method of controlling an image forming apparatus that provides an external device with a plurality of communication interfaces, the method comprising:
determining whether a request to store settings corresponding to each of a plurality of communications interfaces provided by the image forming apparatus has been input;
providing a user interface to input or edit the settings corresponding to each of the plurality of communication interfaces provided by the image forming apparatus if it is determined that the request is input; and
storing the input or edited settings.

35. The computer-readable recording medium of claim 34, further comprising:
driving of the image forming apparatus according to the stored settings corresponding to the communication interfaced used to communicate between the external device and the image forming apparatus.

36. An image forming apparatus that provides an external device with a plurality of communication interfaces, the image forming apparatus comprising:
a communication unit to communicate with an external device;
an interface determination unit to determine one of a plurality of communication interfaces used to receive data from the external device;
a settings storage unit to store settings associated with each of the plurality of communication interfaces;
a settings input unit to provide an interface to input or edit the settings stored in the settings storage unit.

37. The image forming apparatus of claim 36, further comprising:
a control unit to control the driving of the image forming apparatus according to the stored settings corresponding to the communication interface used to communicate between the image forming apparatus and the external device.
